(19) United States
(12) Patent Application Publication
(10) Pub. No.: US 2007/0169555 A1
(43) Pub. Date: Jul. 26, 2007

(54) DISPLAY UNIT WITH SOUND GENERATION SYSTEM

(75) Inventors: Peng Gao, Singapore Science Park II (SG); Xiaobing Sun, Singapore Science Park II (SG); Kanzo Okada, Singapore Science Park II (SG)

Correspondence Address: BELL, BOYD & LLOYD, LLP, P. O. BOX 1135, CHICAGO, IL, 60690, US

(73) Assignee: Sony Corporation, Tokyo (JP)

(21) Appl. No.: 11/560,651

(22) Filed: Nov. 16, 2006

(30) Foreign Application Priority Data
Jan. 22, 2006 (SG) 200600332

(51) Int. Cl. H04R 1/02

(52) U.S. Cl. 73/620; 181/141

(57) ABSTRACT

An audio-visual reproduction apparatus is provided. The audio-visual reproduction apparatus includes a visual display screen and an ultrasonic transducer array having two or more transducer elements arranged around the periphery of the screen for generating an ultrasonic beam modulated with an audio-frequency signal. Non-linear effects in the air demodulate the audio-signal to generate an audio beam propagating perpendicular to the screen. Such an integration of audio and vision may make the user feel as if the sound is being generated from the display screen when he or she is watching it, and also may project the sound towards a target user and seldom, or never, disturb unrelated persons. The ultrasonic transducer array may be made up of independent transducer elements, or may comprise two or more sub-arrays of transducer elements.

### CROSS REFERENCES TO RELATED APPLICATIONS

The present application claims priority to Singapore Patent Application 200600332-1 filed on Jan. 11, 2006, the entire contents of which is incorporated herein by reference.

### BACKGROUND

The present application relates generally to a display unit, such as a display unit provided in an automobile or in an item of consumer electronics such as a TV set, a computer or a mobile phone etc. In particular, the present application relates to a display unit having a sound generation system. Such a unit is referred to herein as an audio-visual reproduction apparatus.

A conventional audio-visual reproduction apparatus includes a screen on which images can be generated and cone-type electromagnetic speakers disposed on both lateral sides or above-and-below the screen. Unfortunately, such an arrangement results in non-collocation between the visual information on the screen and the generated sound.

It would be desirable to make the user feel as if the sound is being generated from the display screen, and some efforts have been made to try to achieve this. For example, U.S. Pat. No. 5,400,414 discloses an electromechanical transducer made of a piezo-polymer film. This film is transparent and is applied to a television screen, glass pane of a framed picture, or the like. Although such an arrangement achieves audio-visual integration, the generated sound can be heard both by a target user and by others. This is because the sound generation system is omni-directional. One way to overcome this problem would be to use earphones or headphones. However, it is not always comfortable to wear an earphone or a headphone for a long time. In addition, it is not safe for certain persons, e.g., car drivers while driving, to wear an earphone or headphone.

Another known type of sound generation system is a so-called “parametric speaker”. A parametric speaker employs an ultrasonic transducer array (that is, an array composed of a plurality of transducer elements). The array is capable, under the control of an applied electronic signal, of transmitting into air a narrow ultrasonic sound beam. The ultrasonic sound beam is AM modulated using an audio signal, by using the audio signal to modulate the electronic signals which drive the ultrasonic transducer array. The AM modulated ultrasonic beam is spontaneously demodulated as the beam propagates through the air because of non-linear acoustic effects, so as to generate an audible sound corresponding to the input audio signal. Parametric speakers use this phenomenon to produce a sound spotlight that is audible only by people at the location of the sound spotlight.

### SUMMARY

In general, the present application includes an audio-visual reproduction apparatus which includes a visual display screen, and an ultrasonic transducer array for generating an ultrasonic beam and including two or more elements located around the periphery of the display screen. At least a portion of transducer array is empty or transparent, through which the display screen is visible. When a parametric control signal (an ultrasonic signal modulated by an audio-frequency signal) is applied to the transducer array, a directed ultrasonic beam is generated. Non-linear effects in the air demodulate the audio-frequency signal to generate, in effect, an audio beam propagating perpendicular to the screen.

Such an integration of audio and vision may make the user feel as if the sound is being generated from the display screen when he or she is watching it, and also may project the sound towards a target user and seldom, or never, disturb unrelated persons.

In an embodiment, the ultrasonic transducer array can include independent transducer elements, or alternatively can include two or more sub-arrays of transducer elements (e.g. closely adjacent one another).

Identical parametric signals may be applied to the individual sub-arrays, e.g. via a common amplifier. Alternatively, different parametric signals may be applied to different sub-arrays, e.g. via individual respective amplifiers. The gain for each amplifier may be selected to be the same. Alternatively, the respective gains may be selected, for example, to steer the sound beam from one angle to another one.

One possibility is for there to be two sub-arrays, for example, where the two sub-arrays are arranged to receive control signals derived respectively from left and right stereo channels.

The transducer elements may be formed separately, and mounted in relation to the display screen (e.g. onto a casing of the display screen). Alternatively, the transducer elements may be integrated, e.g. embedded, in a casing of the display screen.

The transducer elements of the array may take various forms. For example, each said transducer element can include a respective piezoelectric unimorph or bimorph element having a cone-shaped impedance layer. Alternatively, the transducer array can include a membrane with control circuitry being attached to the membrane to permit it to be driven by a parametric control signal. For example, the membrane may be driven by piezoelectric material located on the membrane and arranged to receive a parametric control signal.

Alternatively, the membrane may be driven by electrostatic forces between first conductive material located on the membrane and second conductive material located off the membrane, the first and second conductive materials being arranged to receive a voltage difference determined by the parametric control signal.

In an embodiment, a television receiver is provided, where a display screen is the screen of the television receiver.

In another embodiment, the audio-visual reproduction apparatus is provided in a vehicle, such as a car, bus or even airplane. The audio-vision reproduction apparatus may be arranged on the rear of a seat in the automobile. Alternatively, such an apparatus may be arranged beside the driver, serving as a personal navigation system. One possibility is for the role of the display screen in the audio-visual reproduction apparatus to be played by a mirror of the vehicle, such as the rear mirror, and for the transducer array to be arranged to generate audible sound to be heard by the driver only.

In another embodiment, the display units of computers, such as laptop or desktop computers, are provided. The display unit can include the display screen and a rectangular transparent panel forming a protective cover resiliently mounted on the display unit along the periphery of the display unit by means of a resilient suspension. The ultrasonic transducer elements may then be mounted on, or integrated into, the periphery of the protective cover.

In a further embodiment, any suitable other portable item of consumer electronics, e.g., a mobile radio telephone, cell phone, and the like are provided.

Additional features and advantages are described herein, and will be apparent from, the following Detailed Description and the figures.

### BRIEF DESCRIPTION OF THE FIGURES

FIG. 1 shows an embodiment which is a television receiver with a picture screen encircled by a ring of adjacent, spaced apart PZT unimorph or bimorph ultrasonic transducer elements.

FIG. 2 schematically indicates sound generation according to FIG. 1;

FIG. 3 shows an embodiment which is a television receiver having a picture screen and eight sub-arrays of transducer elements distributed around four edges of the screen;

FIG. 4 shows schematically how a parametric signal is applied to the individual sub-arrays according to FIG. 3;

FIG. 5 shows experimental results of sound pressure level (SPL) versus position generated according to FIG. 3;

FIG. 6 shows schematically the process for producing the experimental results of FIG. 5;

FIG. 7 illustrates schematically an embodiment which is a display unit located in an automobile.

FIG. 8 shows an embodiment which is a laptop/desktop computer;

FIG. 9 illustrates the generation of sound by a further embodiment;

FIG. 10, which is composed of FIGS. 10(a) and 10(b), illustrate membrane-type ultrasonic transducer arrays suitable for use according to an embodiment;

FIG. 11 shows a further embodiment which is a mobile radio telephone or cell phone; and

FIG. 12 shows a further embodiment which is a mobile telephone having a parametric speaker attached to the edges of a display screen.

### DETAILED DESCRIPTION

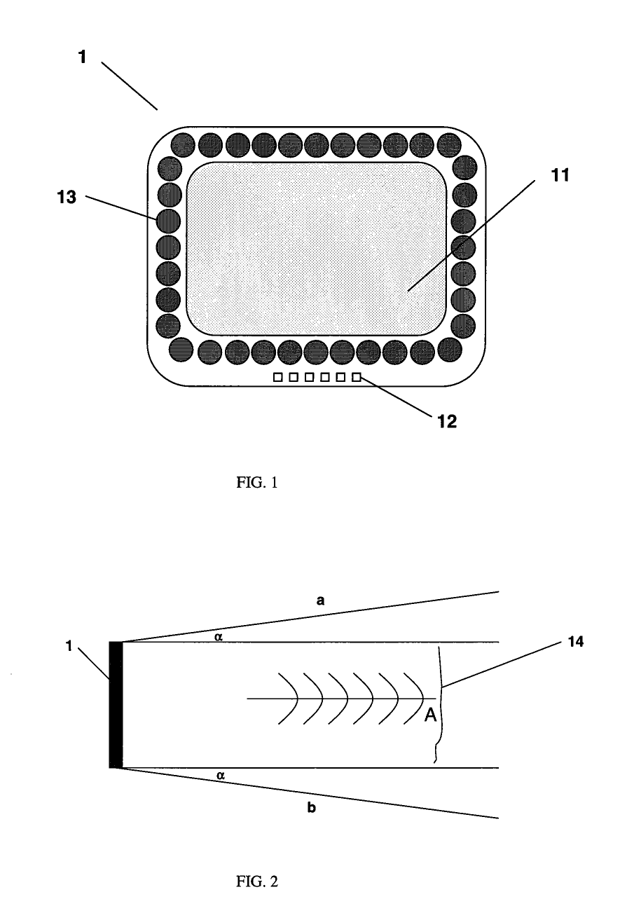

Referring to FIG. 1, an embodiment is shown which is a television receiver 1 with a display screen 11 and control elements 12 (for example, buttons or other devices for inputting control signals). Around the display screen 11 are distributed PZT unimorph or bimorph ultrasonic transducer elements 13 adjacent to each other in at least one ring. The elements 13 can be considered as collectively forming an array of elements spanning a two-dimensional region (which may, for example, be defined exactly as the minimal two-dimensional convex hull containing all the elements 13). A portion of the array is empty and the display screen is visible through the empty portion.

The elements 13 may be integrated with the television receiver (e.g. permanently embedded in a housing of the television receiver). Alternatively, they may be attached removably to the housing around the edges of the screen. When a parametric signal is applied to the transducer array via an amplifier, the elements 13 generate directional primary (ultrasonic) waves in the air. Nonlinear interaction between the airborne ultrasonic waves results in directional secondary (audible) waves.

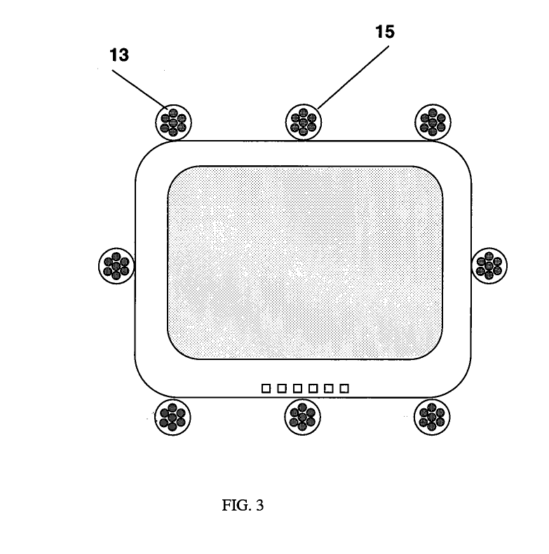

In spite of the central empty portion of the array, our experiments have shown that the demodulated sound pressure level (SPL) in the central is still stronger than in conventional display devices. By adjusting the dimensions of the array, or the density of its elements 13, the demodulated SPL in the main beam and display space can be made uniform. This is illustrated schematically in FIG. 2, which shows the sound field generated by the embodiment of FIG. 1. The curves 14 represent the regenerated audio waves (i.e. the demodulated ultrasonic waves), and at the location A they are close to being uniform. The main audible sound field is constrained within the range between the lines “a” and “b”, meaning that a highly-directional sound beam is achievable. These results indicate that such an audio-vision reproduction apparatus may achieve the functions of (i) making the user feel as if the sound is being generated from the display screen when he/she is watching it, and (ii) projecting the sound towards a target user and seldom (or never) disturbing unrelated persons.

Whereas in FIG. 1, the PZT unimorph/bimorph transducer elements are arranged adjacent to each other to form an array with an empty central portion, as shown in FIG. 1, an alternative embodiment is shown in FIG. 3. Here, there are a total of 8 sub-arrays 15 (although the number of sub-arrays is limited to this number and there may be any number of sub-arrays, particularly any number greater than two). Each sub-array may contain ultrasonic transducer elements closely adjacent to each other, e.g. in the form of a honey-comb structure. The sub-arrays 15 are attached to four edges of a television receiver. The spacing of neighbouring elements within each sub-array is smaller than the spacing of the sub-arrays from each other.

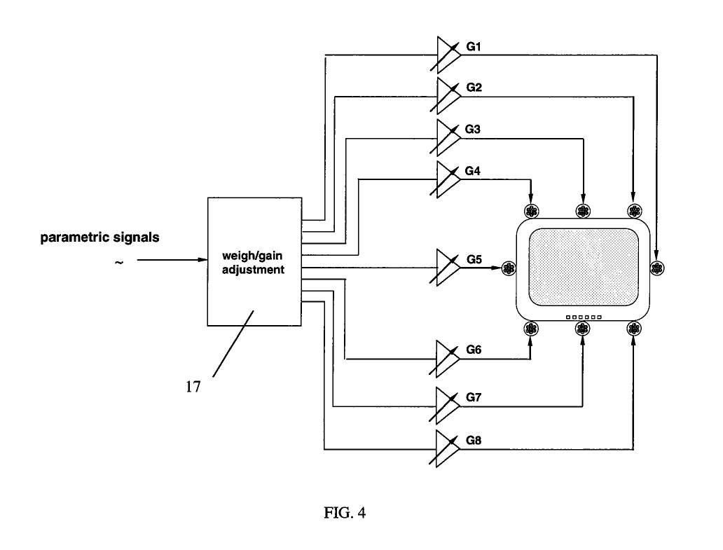

Optionally, all the sub-arrays may be fed the same parametric signal (that is, an ultrasonic signal modulated by an audio signal). In this case, the parametric signal may be transmitted by a common amplifier to each sub-array. Alternatively, as shown in FIG. 4, a parametric signal may be transmitted to a unit 17 which divides the signal into 8 different channels, each of which is transmitted to a respective individual variable amplifier G1, . . . G8, and then to a respective one of the sub-arrays. The unit 17 controls the gains of the variable amplifiers G1, . . . G8. The gain of each amplifier G1, . . . G8 may be selected to be the same. Alternatively, it may be selected to be different for each amplifier G1, . . . G8 (the gains may be limited to real values, or optionally the amplifiers G1, . . . G8 may be capable of providing a complex gain value). Adjustment of the gain value of each of the amplifiers G1, . . . G8 may, for example, be performed according to techniques known in the field of parametric speakers, to result in the sound beam being steered from one angle to another one.

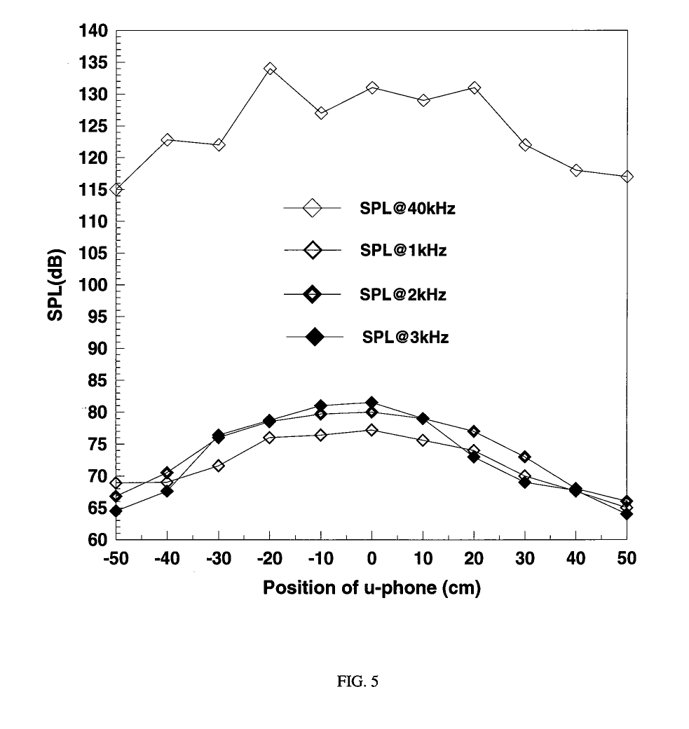

Experimental SPL results for a system resembling the second embodiment of FIG. 3 (in the case that all gains G1, . . . G8 are equal) are shown in FIG. 5. However, whereas in FIG. 3 there are eight sub-arrays substantially equally spaced out in a ring around the screen, and each of the sub-arrays consists of a single central transducer surrounded by six transducer elements in a ring, in the version used to generate the data of FIG. 5 there were six sub-arrays substantially equally spaced out in a ring around the screen, and each of the sub-arrays is composed of 4 concentric rings of transducer elements. Specifically, there was a first ring (i.e. ring of lowest radius) including 5 elements, a second ring of 11 elements, a third ring of 17 elements, and a fourth ring of 24 elements.

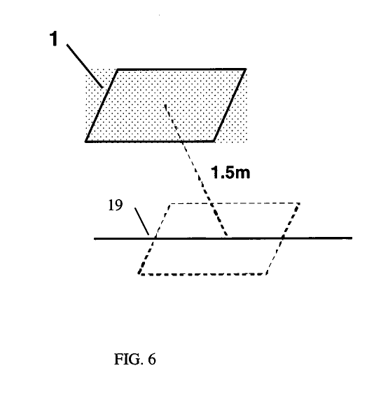

These results were obtained, as indicated schematically in FIG. 6 by moving a measurement microphone moving along a line 19 in a plane parallel to the audio-vision reproduction apparatus and spaced from it by 1.5 m. The position shown in FIG. 5 as “0 cm” corresponds to the microphone being positioned directly forward (in the propagation direction of the sound) from the centre of the screen.

As shown in FIG. 5, the ultrasonic SPL at the central position is smaller than that at other positions (especially the positions at about +20 cm and −20 cm). However, the demodulated SPL is not weaker accordingly. In other words, such an arrangement achieves improved conversion efficiency from ultrasonic energy into the audio-frequency energy near the centre of the sound beam. In the main sound beam, the demodulated SPL tends to be uniform.

Note that in some embodiments it may be worth increasing the width of the empty portion of the array. This will have the effect of broadening the region within which the peak of the demodulated audio signal has a high SPL, and thereby produce a highly-directional sound beam covering more listeners.

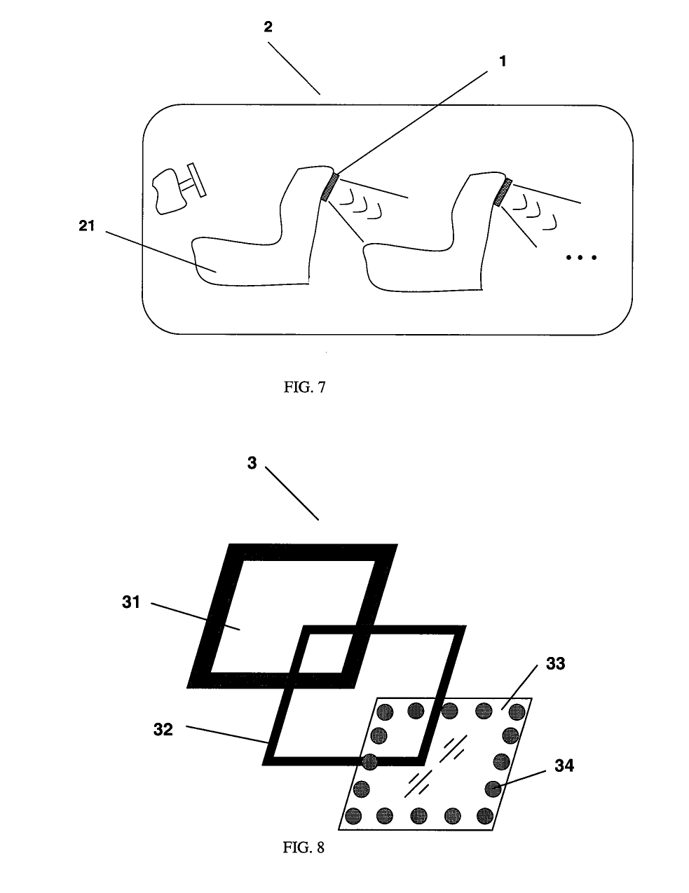

FIG. 7 shows one application of an audio-visual reproduction apparatus 1 which is an embodiment of the invention. An audio-visual reproduction apparatus 1 is provided on the rear of each seat 21 in a vehicle 2, which may be a car or bus, or even an airplane. An individual in the vehicle may watch a TV program or listen to music generated only by the apparatus to his or her front. As a result, he or she may select TV or radio programs according to what he or she wants, and his or her neighbours in the vehicle are not disturbed since the sound is transmitted to the individual as a directed beam. In contrast to conventional ways of restricting generated sound to a single individual (e.g. earphones or headphones), in this application the user does not have to wear any potentially uncomfortable device. Moreover, unlike the use of earphones or headphones, there may be collocation in the application of FIG. 7 between the visual information on the screen and the corresponding audio sound. In other words, the user feels as if the sound is being generated from the display screen.

While in FIG. 7 each audio-visual reproduction apparatus 1 is shown positioned on the rear of a respective seat, the disclosure is not limited in this respect. For example an audio-visual reproduction apparatus 1 may be positioned proximate the driver of the vehicle, e.g. serving as a personal navigation system in which the screen of the apparatus 1 is used to display direction information (e.g. a map) and the sound generation system is used to generate direction instructions.

In another embodiment, role of the display screen of the apparatus 1 may be played by a mirror of the vehicle (rather than being an image generated based on electronic signals). In this case, the parametric speaker may be formed (and optionally integrated with) the mirror in the automobile, and may face the driver so that an audible sound may be heard by the driver only.

FIG. 8 is a schematic exploded view of a further embodiment which is a display unit of a laptop or desktop computer 3. The display unit of the computer 3 includes a visual display screen 31, and in front of it a rectangular transparent panel 33 forming a protective cover. The transparent protective cover 33 may be resiliently mounted onto the display unit along the periphery of the cover 33 by means of a resilient suspension 32, e.g., of foam rubber. The resilient suspensions functions to connect the protective cover 33 onto the display unit of the computer, and further isolates the display unit from any unwanted vibration. The ultrasonic transducer elements 34 of the embodiment are mounted on the surrounding periphery of the protective cover, and together define a two-dimensional transducer array including a central empty portion through which the display screen 31 is visible.

The embodiment of FIG. 8 may function as a personal multimedia system. In this case, directional sound is emitted towards a user by inputting a parametric signal to the transducer array. The user might feel as if the sound is being generated from the display screen 31 when he or she is watching it since the audio and visual messages are integrated together. Note that this is in contrast to conventional computers in which the audio devices are arranged beside the computer display.

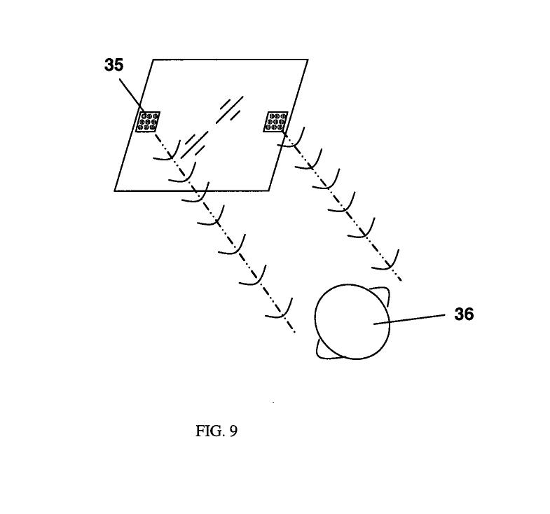

In a variant of the embodiment of FIG. 8, shown in FIG. 9, the transducer array includes two sub-arrays 35 on the surrounding periphery of protective cover 33. The audio source signals from two channels may be pre-processed and modulated to form parametric signals, and then amplified as respective inputs of the two ultrasonic transducer sub-arrays 35. A stereo audio effect may be achieved by this configuration. One sub-array may function as a left-channel ultrasonic speaker, and the other as a right-channel ultrasonic speaker.

Various transducer elements or arrays may be adopted for use as the ultrasonic transducer elements according to an embodiment.

For example, the transducer array can be formed of commercially-available PZT ultrasonic transmitters including a piezoelectric unimorph/bimoroh element and a cone-shaped impedance layer. The parametric speaker device may be made up of these independent ultrasonic elements, particularly if they are connected in parallel electrically.

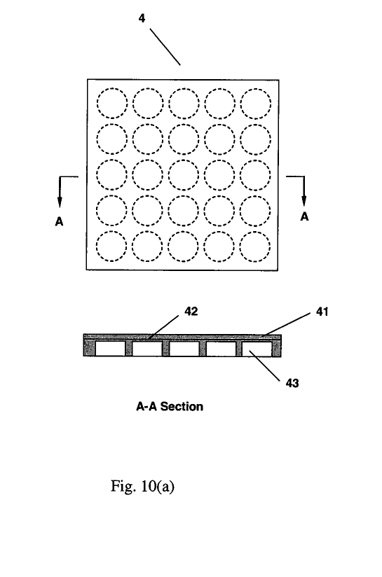

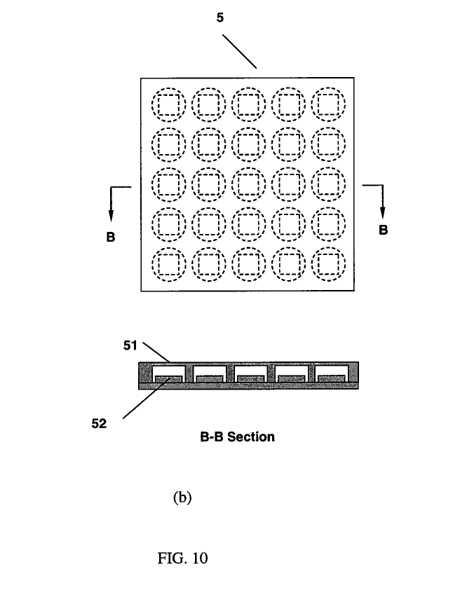

Alternatively, membrane-type elements may be adopted as the transducer elements. A suitable membrane-type transducer is described in Singapore patent application No. 200300490-0 (the disclosure of which is incorporated herein by reference). FIG. 10(a) shows another suitable monolithic transducer array 4 including membrane-type elements. The membrane in the transducer 4 includes at least two layers: a backing layer 42 selected from a wide range of materials such as metal, plastics and silicon; and an active layer 41 which is a functional material such as a piezoelectric ceramic material. Under the membrane are back cavities 43. Vibration of the monolithic piezoelectric membrane at its resonant point will result in emission of an ultrasonic wave into the air.

FIG. 10(b) shows an alternative suitable transducer array 5 including a capacitive membrane. The capacitive ultrasonic transducer array has a general structure resembling FIG. 10(a) in which a membrane 51 is stretched across a frame having multiple back-cavities, but in contrast to the transducer of FIG. 10(a) the transducer of FIG. 10(b) comprises two parallel plates. The membrane 51 in the FIG. 10(b) may function as a positive capacitive plate when it is conductive. Alternatively a conductive layer may be deposited onto the membrane 51 when it is non-conductive. Opposite the membrane 51 is a ground plate 52. It is preferable to adopt a small clearance between the two plates.

A separate membrane-type transducer (e.g. as in FIGS. 10(a) and 10(b)) may be employed as each of the transducer elements 13 of FIG. 1. Alternatively, a single membrane may extend between multiple transducer elements 13 having a geometry which means that different regions of the membrane constitute independent membrane elements. Similarly, a separate membrane-type transducer may be employed for each respective transducer of each sub-array 15 of FIG. 3, or alternatively separate membranes may extend across all the transducers of each respective sub-array.

In an embodiment, the membrane-type ultrasonic transducer arrays of FIGS. 10(a) and 10(b) may be integrated with a protective cover. The protective cover may serve as a substrate which can be patterned to form for example the back-cavities of the transducer. After that, functional materials such as sheets of ceramic-based piezoelectric materials (e.g. PZT, lead zircornate titanate) and/or polymer-based piezoelectric materials (e.g. PVDF, polyvinylindine fluoride) may be bonded onto the substrate to form an ultrasonic transducer array in the periphery of the protective cover.

Such a tiny and thin parametric speaker might also be integrated with a portable consumer electronic device to form a personal audio-visual apparatus, capable of (i) making the user feel as if the sound is being generated from the display screen when he or she is watching it, and (ii) projecting the sound towards a target user and seldom (or never) disturbing unrelated persons.

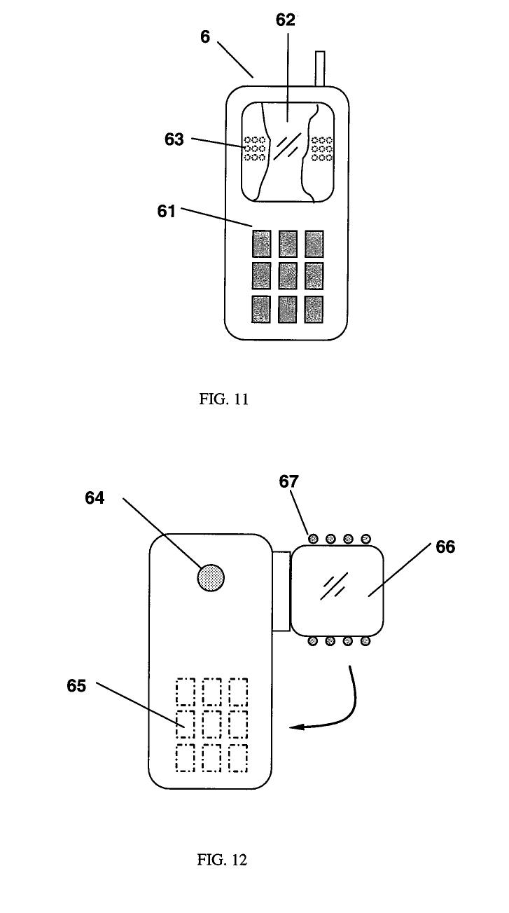

For example, FIG. 11 shows an embodiment which is a mobile radio telephone or cell phone 6 comprising a casing 61 containing, in conventional fashion, a transparent protective layer 62 mounted on the casing through which visual information generated on a screen behind the layer can be observed. A parametric speaker 63 (e.g. of a membrane type as described above in relation to FIG. 10) may be incorporated (e.g. hidden) in the protective layer 62. Various patterns, such as a shallow-hole array, may be fabricated in the protective layer 62 directly, and a sheet of functional material is then bonded onto the patterned substrate to form an ultrasonic transducer array which functions as a parametric speaker when an amplified parametric signal is input to the array.

Alternatively, the parametric speaker may be formed by mounting independent ultrasonic transducer elements or sub-arrays 67 on a mobile telephone adjacent to each other at the edges of a display screen 66, as shown in FIG. 12. The telephone may include a small camera 64 and buttons 65 to operate the telephone. The telephone may be arranged to be foldable. In this case, the personal audio-vision reproduction apparatus may be hidden in the main module when it is not in a working state.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An audio-visual reproduction apparatus comprising:
a display screen; and
an array of ultrasonic transducer elements for generating an ultrasonic beam, the array of ultrasonic transducer elements comprising two or more transducer elements located around a periphery of the display screen.

2. An apparatus according to claim 1 wherein the transducer elements are arranged as two or more sub-arrays of closely adjacent transducer elements.

3. An apparatus according to claim 2, further comprising a respective amplifier for each of the sub-arrays of transducer elements, and a controller for independently controlling a respective gain associated with each of the amplifiers.

4. An apparatus according to claim 2, wherein the sub-arrays include two sub-arrays, the two sub-arrays being arranged to receive control signals derived respectively from left and right stereo channels.

5. An apparatus according to claims 1, further comprising a casing for the display screen, the transducer elements being integrated in the casing of the display screen.

6. An apparatus according to claim 1, wherein each said transducer element comprises a respective piezoelectric unimorph or bimorph element and a cone-shaped impedance layer.

7. An apparatus according to claim 1, wherein the array of ultrasonic transducer elements comprises a membrane driven by piezoelectric material arranged to receive a parametric control signal.

8. An apparatus according to claim 1, wherein the array of ultrasonic transducer elements comprises a membrane driven by electrostatic forces between first conductive material located on the membrane and a second conductive material located off the membrane, the first and second conductive materials being arranged to have a voltage difference determined by a parametric control signal.

9. An apparatus according to claim 1 which is a television receiver, the display screen of the apparatus being the screen of the television receiver.

10. An apparatus according to claim 1 which is located in a vehicle.

11. An apparatus according to claim 10 which is located on a rear position of a seat of the vehicle.

12. An apparatus according to claim 10 in which the display screen is located for viewing by a driver of the vehicle.

13. An apparatus according to claim 12 which is a navigation system, the display screen being arranged to display navigation information and the transducer array being arranged to transmit audio navigation instructions.

14. An apparatus according to claim 12 in which the display screen is a guidance mirror of the vehicle.

15. An apparatus according to claim 1 which is a display unit of a computer.

16. An apparatus according to claim 15 in which the display unit comprises a transparent protective panel resiliently mounted extending across the front of the display screen, the ultrasonic transducer elements being located on the surrounding periphery of the protective panel.

17. An apparatus according to claim 1 which is a mobile radio telephone or a cell phone.
